(19) United States
(12) Patent Application Publication
(10) Pub. No.: US 2016/0104261 A1
(43) Pub. Date: Apr. 14, 2016

(54) SYSTEMS AND METHODS FOR INTEGRATING AN E-LEARNING COURSE DELIVERY PLATFORM WITH AN ENTERPRISE SOCIAL NETWORK

(71) Applicant: Zoomi, Inc., Malvern, PA (US)

(72) Inventors: Christopher Greg Brinton, Berkeley Heights, NJ (US); Mung Chiang, Princeton, NJ (US); Sangtae Ha, Superior, CO (US); William D. Ju, Mendham, NJ (US); Stefan Rudiger Rill, Augsburg (DE); James Craig Walker, Chester Springs, PA (US); Weiyu Chen, Chicago, IL (US); Da Cao, Philadelphia, PA (US)

(21) Appl. No.: 14/876,239

(22) Filed: Oct. 6, 2015

Related U.S. Application Data
(60) Provisional application No. 62/061,652, filed on Oct. 8, 2014.

(51) Int. Cl. G06Q 50/20; G09B 5/02; G09B 7/00; G06Q 50/00

(52) U.S. Cl. CPC G06Q 50/2057; G06Q 50/01; G09B 5/02; G09B 7/00

(57) ABSTRACT

The present invention is directed towards systems and methods for integrating electronic learning (eLearning) platforms with Enterprise Social Networks (ESNs) in corporate learning settings.

The present invention claims priority to U.S. Provisional Patent Application No. 62/061,652, filed on Oct. 8, 2014 and incorporated herein by reference.

### TECHNICAL FIELD OF THE INVENTION

This disclosure generally relates to software systems, and more specifically to the integration of two software systems within an enterprise environment.

### BACKGROUND OF THE INVENTION

Corporations today contain a wide range of third-party software systems that are used for learning purposes, such as for training and development. Examples of these include Learning Management Systems (LMS), such as that provided by Saba, and Enterprise Social Networks (ESN), such as that developed by Jive. ESNs in particular are used to promote a social atmosphere among employees, so that they can connect and communicate with one another, either strictly for socialization or to share ideas and knowledge specific to the workplace. In addition, a LMS can include a social network functionality which falls under the term ESN.

Corporations have also begun to supplement traditional face-to-face, instructor-led training classes with electronic learning (eLearning). In some cases, the entirety of the instruction, for a single course or otherwise, may be delivered online using eLearning software systems, where the courses contain and allow for a wide range of content modes from which employees or other students can learn. These content modes include video, audio, text, and images, possibly among other forms, which can be integrated with one another as appropriate. Note that module here is defined to be collection of accessible files to be delivered to users, with a full course being defined as a collection of modules. Moreover, these software systems themselves may include means for social interaction among employees, a feature which can work complimentary to that provided by an ESN; namely, employees who interact within the social component of the course may also do so via ESN, and vice versa.

Hence, it is desirable to develop systems and methods to integrate eLearning courses and their associated delivery platforms with ESNs.

### SUMMARY OF THE INVENTION

The present invention is directed towards systems and methods for integrating electronic learning (eLearning) platforms with Enterprise Social Networks (ESNs) in corporate learning settings. A standard ESN provides employees at a corporation an environment for social learning, where they can share ideas and knowledge with one another through posts, comments, and other functions within certain employee groups. At the same time, a course delivered through an eLearning platform at a corporation will typically offer employees some means for social interaction, such as through exchanging notes, comments, messages, or external links. A prime example of such a course is as an Integrated and Individualized Course (IIC), which integrates various learning modes into the platform, including those for social learning, and personalizes the content delivery based on a user model that is continuously updated based on user interaction with the learning modes. Therefore, providing integration between these two platforms has a number of benefits in terms of social knowledge creation among employees. As it pertains to integration between IICs and ESNs, the present invention includes, but is not limited to: IIC user authentication through an ESN, the creation of discussion threads in an ESN from IIC user-generated content, the notification of changes occurring in ESN discussion threads at the IIC device, the sharing of group definitions between IIC platforms and ESNs, and the initialization of user models for individualization in the IIC based on ESN profiles.

The present invention describes a plurality of systems and methods for integrating courses and/or course content arranged on eLearning platforms with Enterprise Social Networks (ESNs) in corporate settings directed to students/employees (“students” or “employees”). The courses delivered by the eLearning platforms may be integrated, meaning they support the delivery of a wide range of learning modes (e.g., video, text, slides, audio, and other forms of media or multimedia content), and individualized, meaning the content changes based on a user model that is continually updated based individually for a student or employee, based on each individual's interaction with the course. Interaction here means each student's viewings, duration of visibility of a display on a user's screen, mouse clicks/scrolls, results of testing, and the like, all of which are tracked and used to adjust course delivery during the individual's use of the course. Hence, these courses and the eLearning platforms that are used as delivery platforms are collectively generally referred to as Integrated and Individualized Courses (IICs), though the present invention is just as applicable when the courses are neither integrated nor individualized.

The eLearning platform includes processor capability with interfaces to a web server and a communications port for communicating to students, as well as a data store. The data store maintains data with course content, user results (such as but not limited to tracking results and test results) and user comments. Course content can take any of several forms, such as but not limited to video, text, image, audio, or a combination. Courses are preferably delivered as a series of modules, where the aggregate collection of modules delivered to any student encompasses the entirety of a syllabus, but the modules delivered to a particular student may vary based on a number of parameters, such as student success on assessments and duration of watching certain aspects of a module. The path a student progresses through a course can be based on the student's trajectory together with student success, where the combination is compared to a transition vector, also stored in the data store. The eLearning platform's processor determines the student success, compares the success to the vector and determines and delivers the next module to the student. This process is shown schematically in FIG. 4.

One specific mechanism by which social interaction occurs in these courses is through the process of sharing content and/or annotations generated by the learners themselves, meaning that employees create content based on the platform functionality and can choose a group of employees (if any) with whom to share it. This content could be annotations, such as but not limited to notes, snippets of course-related video or text, or images. Interaction within an ESN, on the other hand, is based on discussion threads between employees, but like shared notes, each discussion thread is managed by a specific group of employees.

For example, a course might be directed to a traditional administrative function. The course could be “generic” and not purely customized to the particular enterprise. The course might be available as an accessible series of modules (each module being a collection of files) on a cloud server, where the modules are selectable and sequence-able based on a particular student's characteristics (e.g., job function, prior course history and performance, test results, etc.), but delivered such that all requisite portions of the course are included in some way. Individuals in an enterprise can access the course, and delivery to those individuals may be based on authenticating the individual and customizing for that individual. As individuals in the enterprise access the course or portions of it, those individuals have the opportunity to comment on the content, such as by entering textual or audio annotations, and those comments could be and should be accessible by others in the enterprise (or companion enterprises) that are, in at least some way, similarly situated as the commenting individual. An example of such a comment might be an employee entering a flow chart of how that enterprise does a certain function and having the flow chart appear on the screen of later users who access this same module.

Similarly situated could include, for example, those in the same work group, building, time zone, etc.

To continue the example, once a first commenter adds annotations, a second commenter can amend the annotations, such as to update information. The amendments are tracked in such a way that the author of each change can be identified.

As it pertains to integration between IICs and ESNs, the present invention includes, but is not limited to: IIC user authentication through an ESN, the creation of discussion threads in an ESN from IIC user-generated content, the notification of changes occurring in ESN discussion threads at the IIC device, the sharing of group definitions between an IIC platform and one or more ESNs, and the initialization of user models for individualization in the IIC based on ESN profiles. This integration allows for social knowledge creation among employees jointly through both IIC and ESN.

The direct integration between an IIC and an ESN may not be a function of the ESN, but can be facilitated by the IIC's backend as long as the ESNs offer basic functionalities like an authentication API, the ability to access discussion data and an API to create posts and discussions through an API. The ESN's administrators would then, for example, create spaces/categories in which the users could create discussion threads. Information about these spaces, such as the space identifier, can then be forwarded to the IIC's backend and stored by it. That information can be used to create new posts and discussion threads based on interaction of the users within the IIC environment.

### BRIEF DESCRIPTION OF THE FIGURES

FIG. 1 depicts the process of user authentication via an ESN, using the OAuth standard as an example.

FIG. 2 shows how the creation of a social note within an IIC causes a discussion thread in the ESN for the corresponding group to be created, and how the creator of the note will be notified of any changes or additions to the thread via the callback mechanism.

FIG. 3 shows the process of fetching the potential groups of users that a creator of a note can share with, as defined by the ESN, and in turn storing the note in the IIC backend with an indication as to which users have access to it.

FIG. 4 depicts a schematic diagram of an exemplary embodiment of the eLearning platform of the present invention.

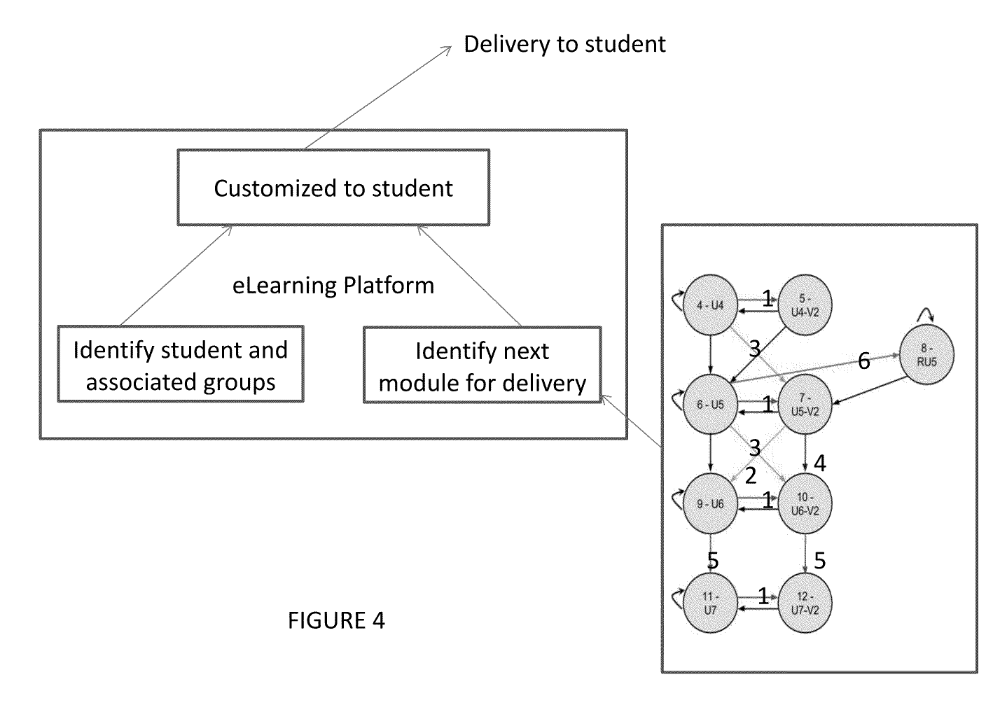

### DETAILED DESCRIPTION OF THE INVENTION

The present invention is directed to a plurality of systems and methods for integrating eLearning platforms with Enterprise Social Networks (ESNs), particularly in corporate settings. In the context of the present invention, is it assumed that the learning scenario within a corporate environment consists of a course or set of courses, organized as a series of modules that are delivered to employees through an eLearning platform, and that an ESN has been established for use by employees engaging in work-related communications.

Although described as applicable to corporate environments, the present invention is equally directed to other enterprise environments, such as but not limited to universities, which entail in-house or access to social networks.

In a corporate training industry, an ESN and an IIC may be used for similar purposes. While employees use IICs for training purposes, they will also tend to discuss work related topics in ESNs. It would therefore be beneficial for the ESN system to feed information discussed back to the IIC for use in course delivery. In other words, the ESN system and the IIC can be integrated to work in a complimentary manner such that information circulates between the two systems.

The term “employee” as referenced herein refers to any person participating in a training and development program utilizing the disclosed embodiments, and is not limited to any particular level or status of a person within the corporation. Additionally, the terms “corporate” and “enterprise” are not specific to any type or size of an organization and does not note a specific type of legal entity; for example, the training could range in size from a sole proprietor attempting to improve his/her performance to a large group of employees within a multinational corporation taking a requisite compliance course. In its broadest form, the present invention provides for middleware between an ESN environment and an eLearning environment.

A goal of the present invention is to fully integrate ESN content with appropriate selections of an IIC on a user-by-user basis. That is, if a first employee annotates an image in a module of an IIC at a particular locale in the image, that same annotation should appear in conjunction with the same image at the same locale when a second employee who is in the same ESN takes that course and views that image in that module (or, perhaps, in other modules). Further, the same annotation can appear in other images or videos (or other medium) when the topical content is equivalent to that of the original location identified for the annotation. Topical equivalence here can be determined in a number of ways. In the case of textual content, a standard natural language processing algorithm can be applied, to extract the keywords from the full corpus of text that appears in the course, where “corpus” is the collection of words. Then, each learning mode can be associated with the keywords that they contain. Annotations placed on modes containing given keywords can also appear near the locations of these same keywords in other modes.

In the context of the invention, the courses delivered via the eLearning platform may integrate a wide range of learning modes, which are the different ways by which the employees can learn the course material. These learning modes include both the files that constitute course material itself (e.g., videos, text, images, slides, simulations), as well as mechanisms for social learning via the sharing of user-generated content and/or annotations. The types of content that can be shared include, but are not limited to notes, highlights, bookmarks, external references, group-work projects, and group messaging.

The baseline course may also contain automated individualization, meaning that the various modules, as well as the specific modes within them, are adapted to each specific employee. The specific adaptation for an employee is generally determined by a user model that is updated automatically and continuously based on the employee's interaction with and performance in the course; in the case of an IIC, the behavioral measurements are captured through appropriate tracking functionality that is embedded in the user application.

With individualization, each employee traverses one of potentially multiple potential learning paths, and many employees can traverse the same learning path. A learning path here is defined as a unique sequence of modules, and particular modifications to modes within modules, that could potentially define a user's course experience. The employees that are on a given path, or similar paths, may be considered to be within a group for purposes of social sharing within the IIC and within the ESN. As students progress through a course, their learning path may be adjusted, such as due to their individual test results, durations viewing key topics, and so on. For example, a student perceived by the system of the present invention as having difficulty grasping a concept can be provided with additional or alternative examples to improve concept retention. Similarity between paths can be quantified in a number of ways, taking into account information including the number of each type of learning mode, the exhibited learning styles of the users on the paths, the length of the paths (in terms of the number of modules), and the difficulty of the material on the path, among other items.

The system of the present invention defines the groups as groups of employees with commonality in some form. That is, a group might be a work group, people living in the same general area, people officed in similar areas, etc. The system of the present invention determines the significance of those groups with respect to the course being taught or offered.

As a result of the potential for integration and individualization in the courses delivered via the eLearning platform, the present invention is preferably directed to Integrated and Individualized Courses (IICs), though the present invention is just as applicable in cases where the courses do not possess these properties. These courses are assumed to be hosted through an IIC backend, which as described herein refers to web service applications that run on a set of servers that may or may not be managed by the corporation. The user device as referred to herein is a device that an employee uses to access the IIC application and communicate with the backend, and can be any computing device that can connect to the Internet, such as a desktop computer, laptop computer, tablet, or smartphone.

In terms of the ESN, the present invention places no limitation on the type of functionality that can be offered, besides the assumption that basic forms of discussion, such as through the creation of discussion threads or the commenting on posts created by others, are available to all employees, and that this interaction occurs in such a way that each employee can select from a set of groups in which the discussion will be visible. The term “group” as referred to herein denotes a set of employees that can communicate with one another via the functions provided by the ESN, and are determined by the corporation. For example, a group could be the set of employees in a certain geographic location or with a certain set of positions, or all those employees on the same learning path as determined by the IIC.

A plurality of non-limiting systems and methods for integrating an eLearning platform with an ESN will now be described. These include: IIC user authentication through an ESN, the creation of discussion threads in an ESN from IIC user-generated content, the notification of changes occurring in ESN discussion threads at the IIC device, and the sharing of group definitions between IIC platforms and ESNs.

The present invention provides for IIC user authentication through the ESN. This is generally accomplished through an initial authentication with the ESN, which is used to establish a flow between the IIC backend and user device for future attempts. The specific mechanism employed may vary slightly depending on the authentication and authorization standard employed; for exemplary purposes, the architecture in the case of OAuth, an open standard for authorization, will be described. Other authentication and authorization schemes may be used for this purpose, such as OpenID, SAML (Security Assertion Markup Language) or that provided by a proprietary corporate system.

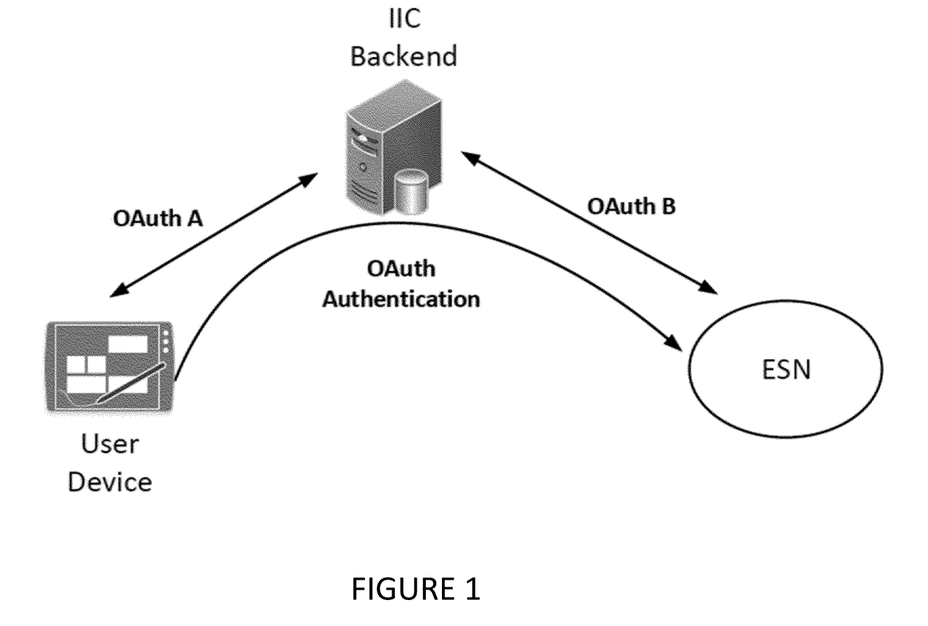

The exemplary OAuth-based authentication process is depicted in FIG. 1. At the initial user login to an IIC application for the corporation, the user device will issue a request to the IIC backend server for the ESN authentication site. The IIC backend provides the device with a redirect to the site, establishing the OAuth authentication flow in the diagram. Then, the user will provide his/her credentials used to log into the ESN. Once the login is successful, the ESN redirects the user application to the URL used by the IIC backend to indicate a login success. Additionally, it provides a variety of information to the IIC backend specific to the user, establishing OAuth B in the diagram: a software token needed for future login attempts by the user, the ESN groups that the user is associated with, and permissions. This information is stored in a secure database contained within the IIC backend. Finally, the IIC backend provides the user device with the corresponding token and information, establishing OAuth A between the backend and the device in order to bypass the ESN for future logins.

Another embodiment of this authentication scheme can be imagined in which the user device communicates directly with the ESN and sends all information to the IIC backend as well.

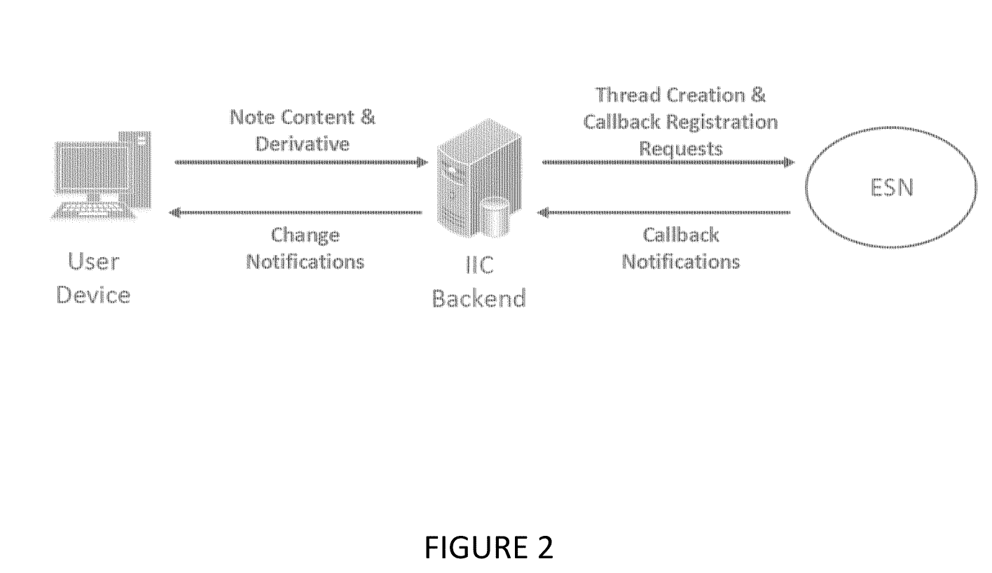

Once a user has authenticated with the ESN, he/she can view and create shared notes through the IIC application. FIG. 2 depicts the method of creating and storing shared notes, translating these to group discussion threads in the ESN, and notifying the creator of the note when new information is available in the respective thread, in a preferred embodiment of the present invention.

Communication between the user device, the IIC backend and the ESN can be executed in a number of ways. One embodiment of this process would utilize REST (Representational State Transfer) APIs. In this case, the user device sends an HTTP request containing a JSON object with the necessary information to the IIC backend, which will then use that information to communicate with the ESN via a second REST API provided by the ESN. The HTTP responses themselves could either contain JSON objects or any other data format. APIs other than REST could also be used for this purpose, such as SOAP (Simple Object Access Protocol), WSDL (Web Service Description Language) or RPC (Remote Procedure Call). Moreover, instead of JSON objects, information based on XML or other formats other could be used. The specific implementation will depend on the feature set that the ESN offers.

When a user creates a note in a specific part of the application, he/she is first queried as to whether this note will be shared or not. The user could also be given the choice of posting it anonymously, if the ESN offers such capabilities and it is a desired functionality. If the user is creating a shared note, the IIC backend will first determine those other users with which this user has permission to share with, a process which will be described further below. Once the corresponding group selection has been made, the content of the note, as well as a derivative representation of that content (e.g., a screenshot) is sent to the IIC backend. The IIC backend will store information needed to display the note in the IIC application for this user and those which the note is shared with, including the content itself and the position within the corresponding learning mode at which the note is to be shown. Then, the IIC backend will instruct the ESN to create a discussion thread that contains the derivative of the note and which is accessible to the group that the creator of the note had specified. At this time, the IIC backend will also request an HTTP callback registration for the thread so that the ESN can notify the backend whenever a user interacts with the discussion thread on the ESN (e.g., through a comment), assuming that the ESN provides such functionality. If the ESN does not provide callback functionality, the IIC backend can query the ESN on a regular basis to see if updates to discussion threads have been made.

Material from the learning modes in the IIC (i.e., in addition to the user-generated textual content) can be used as part of the content in the corresponding post on the ESN; this includes snippets/snapshots/screenshots of text, video, images, slides, and any other modes offered by the course. The only limitation here is the capability of the ESN's interface to display these different types of content. The authoring tools in an ESN system are usually defined in a user-friendly way to post videos, images, text, etc, though.

The ESN of the present invention responds to these requests by creating a corresponding thread, and sending the thread information (including its URL, identifier, and the location in the ESN in which the thread was created) to the IIC backend, where it is stored for future reference, and is in turn shared with the user device of the creator so that the creator can access (and preferably automatically) the corresponding ESN discussion as desired. With the callback registration in place, whenever any updates are made to the thread, such as when a post is rated or modified, a notification is sent to the IIC backend via the callback mechanism, which may in turn trigger a notification (e.g., push notification) to be sent to the user device.

Importantly, the user's interaction is device independent (computer, tablet, smart phone, etc.), but notification would be sent to the device if the device were presently engaged.

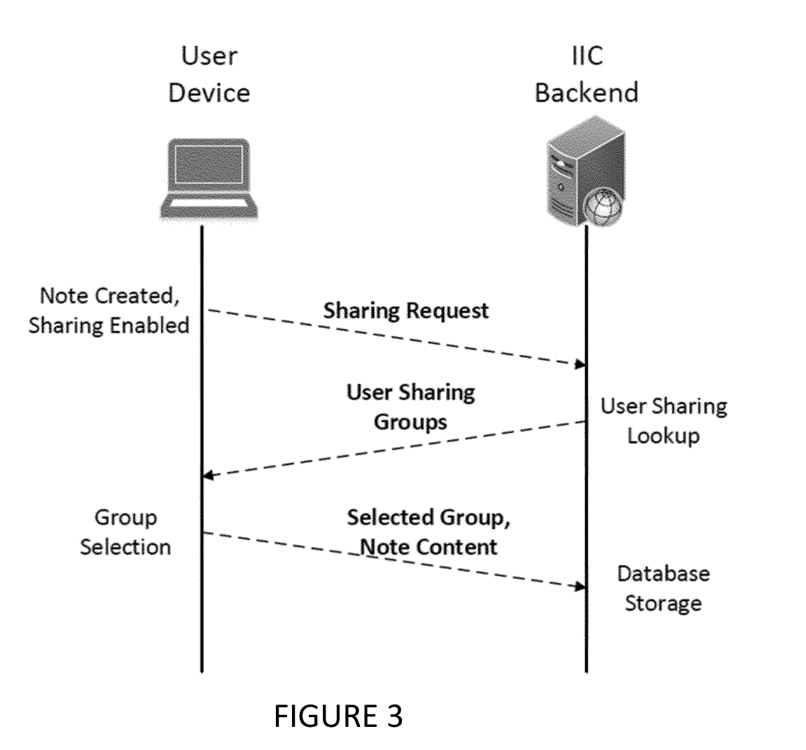

When a user creates a shared note, as stated, the user will have the option to choose from a number of groups in which the user is associated with on the ESN. Again, these groups are preferably defined by the ESN and the corporation, and could be employees in a certain region, employees with a certain job title, and individuals who may work closely together, among other possibilities; the present invention places no limitation on what types of users a given group can encapsulate or if content should be shared with every employee in the corporation who is using the ESN. Employees may have the ability to establish other ESNs as well. The process of determining the specific options a user has in terms of sharing groups is shown FIG. 3. Once a user has elected to share the note, the device will contact the IIC backend, which contains the sharing groups to which the employee belongs. These sharing groups are sent from the ESN to the backend during the authentication process. The backend will return the sharing groups to the device, and the user will then select from the sharing options. Finally, the selection will be sent to the backend and in turn stored for future use.

Another implementation can be imagined where the ESN does not share group information with the IIC. In this case the ESN would be fully responsible for handling the viewing permissions of posts created through the IIC application. For this, the ESN would make use of permission schemes that were setup by its administrators.

Users can also be offered functionality to view a history of the posts they created, as well a summary of actions and changes that occurred to these posts over time. An implementation could be imagined, but is not limited to, a view in the IIC device that displays the history of posts in a table, or list of items that describe the actions and changes. Interacting with these items, such as by simply clicking on them, could then present the user with the content comprising the particular discussion thread.

Depending on the ESNs' capabilities, users could be given the ability to update the content of the post after it has been created, including both their own posts as well as those made by other users in their group. They can also have the option to eliminate the post, or to add comments on the post. Iterative comments on the same post can create a conversation within the thread (much like on social networking sites), and such comments will be notified to the users with visibility (in the same group).

Note also that settings made in the ESN by the corporation can determine the visibility of each thread. For example, one can imagine that only members of a certain group may be able to see threads created or whether training supervisors are able to see the content.

The IIC users who are in the group of employees in which a note has been shared will also receive notifications when these notes have been created, as well as the thread URL for the corresponding ESN discussion thread. These users will also be notified when changes have been made within the IIC or ESN. The present invention can accomplish this process in a number of ways, with three being foregrounded. The first is through a push notification from the IIC backend to these respective clients. The second is through automated requests from the device as to whether shared notes are available within a specific segment of content once it is loaded. The third is through users manually initiating requests. In a preferred embodiment of the present invention, a combination of the first and second will be employed in cases where many users are interacting with a segment simultaneously, so that new notes or thread additions can be notified as soon as they occur.

Users can posts threads on ESNs and will receive notifications when a note has been shared. In the process of creating and sharing, the ESN system will push sharing notifications in a way that maximizes learning utility by connecting people who have one question to people who are most likely to answer this question.

To maximize the learning utility, in the present invention, the backend system first takes down the text data from the forum threads by parsing. To parse the forum data, the backend system needs to remove unnecessary information that is included in script languages (username, time of posts, URL, and etc.) and, in the end, output the content discussed, the votes/likes of each post, and other relevant information.

After the backend system has parsed the data from the ESN, the backend system of the present invention conducts information retrieval via text mining methods. Text mining methods could include, but are not limited to, Latent Dirichlet Allocation (LDA) and Term Frequency-inverse Document Frequency (TF-IDF). The LDA method utilizes iterations of supervised labeling and manual pruning to classify the topics. TF-IDF works similarly, except it focuses more on increasing proportionally to the number of times a word appears in the document while appearing less in a general text corpus. By doing so, the backend system is able to associate forum threads into different topics and learn the key words from each post.

Once parsed, notes related to a topic in one portion of a module could be applied to another portion of the same or another module. That is, the parsing is used to determine significance to that portion of the module and match that significance with similar significance in other portions or other modules. The annotations can then be copied to those other matched elements. The present invention also allows the opportunity to distinguish the source of the annotation (who entered the annotation and was it related to this particular entry or another entry).

With the backend system having obtained the key information, the second step is to evaluate the user's social activity. The backend system evaluates the user's tendency to discuss, to propose a question, and to answer a question. This can be done by collecting the user's previous behavioral data, including but not limit to discussion in a forum post, creation of a forum post, and so on. For example, when a user demonstrates repetitive behavior in adding comments to posts created by other users, then the system can consider the user as having high tendency to answer forum questions.

Once key information is extracted and the user social activity is assessed, the ESN system can connect users to different posts in a way that the user connected is more likely to become involved in the post discussion so that he/she learns by discussing and sharing information with other users. For instance, when one topic regarding laptop security is created, the system will locate the user who has previously discussed a topic similar to laptop security and has demonstrated a high tendency to become involve in forum discussion. Afterwards, this laptop security forum post will be prioritized and the ESN will notify the user. By doing so, the system enhances the probability that more users will respond to a newly created post. One benefit is that users are more connected in topics with which they are familiar and are better able to share the same questions with, and hence they gain information while connecting to these forum posts.

Also, the system of the present invention uses data regarding a user to recommend relevant forum threads as well as relevant course modules. This function will provide additional forum information to users when users learn through the web application. This function will also provide post suggestions when users are browsing relevant forum posts.

To do so, the backend system prepares text for mining, including parsing from the forum data. To preprocess the data and clean the data for proper text mining, the system conducts steps including tokenization, removing punctuation, removing stopwords, and so forth. Tokenization involves breaking a string into word structures. Stopwords are those transition words in sentences which lack context (e.g., ‘the’, ‘and’).

Afterwards, the present invention applies machine learning algorithms to classify and associate each forum post with different topics. These text mining methods include, but are not limited to, the LDA and TF-IDF methods stated above, association rules, and others. By doing so, the backend system can learn the information and extraction the key topic. Then the system classifies each post by topics and evaluate the thread quality by assessing the amount of information contained in the thread. Afterwards, when a user is learning on a specific topic, the relevant threads are ranked by the quality of information and recommended to the user. By doing so, the ESN system incorporates forum threads information inside the present system's player applications. Moreover, the ESN system can recommend forum posts of certain topics when users are browsing similar topics.

Individualization within an IIC requires the initialization and continuous updating of a user model for each employee. The dimensions of the user model are typically dependent on user interaction with the different learning modes in the IIC. By integrating an IIC with an ESN, in a preferred embodiment of the present invention, the parameters of these models can be initialized based on the ESN profile of each employee. For example, employees who tend to post in the same groups may have their user models initialized so they are placed on the same learning paths, so that they can continue their discussions in the IIC in an effort to improve engagement.

In the present invention, the ESN incorporates a function that groups users by measuring their similarity, where similarity is determined through unsupervised clustering algorithms. The purpose of grouping users is that the ESN system is able to provide individualization and recommendations based on these groups.

To do so, the backend system first collects behavioral data from each user. Before the backend system groups each user to different groups in a way that users in the same group demonstrate similar behaviors and performances, the backend system needs to clean the data in a few steps. First of all, the data needs to be de-noised such that trivial playback behaviors are removed, e.g., combining repeated, sequential events that occur within a short duration of one another. Secondly, the system of the present invention will extract features to reduce the high dimensionality. The methods could include but are not be limited to, Principal Component Analysis (PCA), Independent Component Analysis (ICA), and so forth. PCA and ICA in particular can be used to reduce dimensionality, by projecting the data onto a lower dimensional subspace to reduce insignificant noises.

After the data has been preprocessed, a series of clustering methods are applied in order to group users based on similarities in their behaviors. Users of similar behavioral data will be put in the same cluster while users of different behavioral data will be grouped into different clusters. To define similarity, a distance norm is created to quantify the extent to which users are different from each other. The clustering methods could include k-means, k-medoids, hierarchy clustering, and so forth. K-means and k-medoids clustering methods, roughly speaking, are based on repeating the process of assigning data points to the nearest data point centers, re-computing the centers, re-assigning, and so on. The difference between the two lies on the distance matrix defined. Hierarchy clustering, on the other hand, constructs binary tress and groups data in a bottom-up approach. The choice of the number of clusters depends on the data and the behavior of the clusters (i.e., within-cluster variance and between-cluster variance).

Note that such groups are not necessarily formed based on behavioral data over the whole course. In particular, users can be grouped based on exhibiting similar behavior over certain modules of the course, or over similar learning paths. For instance, suppose that user A and user B are grouped into cluster 1 and cluster 2, respectively, over the entire course. In general, they will not receive the same shared information. But if they happen to demonstrate similar behavior within unit 1, information specific to unit 1 can be shared between user A and B.

Overall, the present invention provides a means for social knowledge creation jointly through both IIC and ESN.

1. A method for a processor with access to stored content on a data store to organize and customizably delivery of learning materials to a student, comprising the steps of:
obtaining a plurality of learning modules from said data store, each said learning module comprising student-downloadable learning materials for a syllabus topic;
forming a sequence map of learning modules and potential transitions between learning modules, each said transition assigned a transition vector based on said student's prior module results;
identifying enterprise social networks associated with said student;
extracting at least one user-provided annotation from said data store, said annotation related to and originating from others in said student's enterprise social network:
associating each annotation with at least one specific locale in at least one learning module to be delivered to said student;
delivering a customized a learning module to said student, said learning module encompassing at least one said annotation at said specific locale; and
affording said student the opportunity to add additional annotations for viewing by others in at least one of said student's enterprise social network.

2. The method of claim 1 where said at least one said annotation has been added to by a user, thereby forming threads stored on said data store, and said threads are delivered at said specific locale.

3. The method of claim 1 where annotations for extraction are determined based on cluster methodology.

4. The method of claim 3 where the cluster methodology includes determining a distance norm related to social networks.

5. The method of claim 1 where the student's enterprise social networks are self-identified by the student.

6. The method of claim 1 where the data store includes data on the source of annotations.

7. A system for determining a delivery sequence of learning modules with content customized to a particular student and based on scoring student performance, comprising:
a data store for storing learning module content and
a processor;
wherein said processor is configured for
obtaining a plurality of learning modules from said data store, each said learning module comprising student-downloadable learning materials for a syllabus topic;
forming a sequence map of learning modules and potential transitions between learning modules, each said transition assigned a transition vector based on said student's prior module results;
identifying enterprise social networks associated with said student;
extracting at least one user-provided annotation from said data store, said annotation related to and originating from others in said student's enterprise social network:
associating each annotation with at least one specific locale in at least one learning module to be delivered to said student;
delivering a customized a learning module to said student, said learning module encompassing at least one said annotation at said specific locale; and
affording said student the opportunity to add additional annotations for viewing by others in at least one of said student's enterprise social network.

8. The system of claim 1 where said at least one said annotation has been added to by a user, thereby forming threads stored on said data store, and said threads are delivered at said specific locale.

9. The system of claim 1 where annotations for extraction are determined based on cluster methodology.

10. The system of claim 9 where the cluster methodology includes determining a distance norm related to social networks.

11. The system of claim 1 where the student's enterprise social networks are self-identified by the student.

12. The system of claim 1 where the data store includes data on the source of annotations.

13. A method for integrating an electronically delivered course with an enterprise social network using a processor with access to a data store, where said course is arranged to adjust the online delivery sequence of learning modules of a course, adjusted based on student performance and social contacts, comprising the steps of:
obtaining a plurality of learning modules from said data store, each said learning module comprising student-downloadable learning materials for a syllabus topic;
forming a sequence map of learning modules and potential transitions between learning modules, each said transition assigned a transition vector based on said student's prior module results;
associating at least one enterprise social network with said student;
extracting at least one user-provided annotation from said data store, said annotation related to and originating from others in said student's enterprise social network;
associating each annotation with at least one specific locale in at least one learning module to be delivered to said student;
delivering a customized a learning module to said student, said learning module encompassing at least one said annotation at said specific locale; and
affording said student the opportunity to add additional annotations for viewing by others in at least one of said student's enterprise social network.

14. The method of claim 13 where said at least one said annotation has been added to by a user, thereby forming threads stored on said data store, and said threads are delivered at said specific locale.

15. The method of claim 13 where annotations for extraction are determined based on cluster methodology.

16. The method of claim 15 where the cluster methodology includes determining a distance norm related to social networks.

17. The method of claim 13 where the student's enterprise social networks are self-identified by the student.

18. The method of claim 13 where the data store includes data on the source of annotations.
